(19) United States
(12) Patent Application Publication
(10) Pub. No.: US 2026/0139119 A1
(43) Pub. Date: May 21, 2026

(54) RECYCLING METHOD FOR POLYAMIDES AND COMPOSITES

(71) Applicants: James Eagan, Akron, OH (US); Keaton Turney, Akron, OH (US)

(72) Inventors: James Eagan, Akron, OH (US); Keaton Turney, Akron, OH (US)

(21) Appl. No.: 19/334,261

(22) Filed: Sep. 19, 2025

Related U.S. Application Data
(60) Provisional application No. 63/722,213, filed on Nov. 19, 2024.

(51) Int. Cl. C08J 11/26

(52) U.S. Cl. CPC C08J 11/26

(57) ABSTRACT

A method of recycling a polymer includes steps of contacting a polyamide polymer with an acid, allowing the polyamide polymer to depolymerize in presence of the acid into an amine species and a monomer based on an olefin and carbon dioxide, and collecting the amine species and the monomer. The polyamide polymer can be part of a composite further including fibers as a reinforcing component, such that the step of collecting can further include collecting the fibers.

### CROSS-REFERENCE TO RELATED APPLICATIONS

This application claims the benefit of U.S. Provisional Application No. 63/722,213, filed on Nov. 19, 2024, which is incorporated herein by reference.

### STATEMENT REGARDING FEDERALLY SPONSORED RESEARCH OR DEVELOPMENT

This invention was made with government support under DMR-2144570 awarded by the National Science Foundation. The government has certain rights in the invention.

### FIELD OF THE INVENTION

Embodiments of the present invention relate to a recycling method for polymers, especially polyamides, and corresponding composites.

### BACKGROUND OF THE INVENTION

As a comprehensive approach toward sustainable materials, it is desirable to utilize sustainable feedstocks and recyclable product materials in order to better address environmental impact at the manufacturing and end-of-life stages. International Publication No. WO 2023/164219 discloses polyamides made from carbon dioxide, an olefin, and an amine, and corresponding fiber-containing composites. There remains a desire for improved recycling methods for these polyamides and other materials in order to further improve the carbon footprint of these materials, while also developing a circular economy to provide lower-cost, recycled fibers and monomers back into the supply stream.

### SUMMARY OF THE INVENTION

An embodiment provides a method of recycling a polymer including steps of contacting a polyamide polymer with an acid, allowing the polyamide polymer to depolymerize in presence of the acid into an amine species and a monomer based on an olefin and carbon dioxide, and collecting the amine species and the monomer. The polyamide polymer can be part of a composite further including fibers as a reinforcing component, such that the step of collecting can further include collecting the fibers.

### DETAILED DESCRIPTION OF ILLUSTRATIVE EMBODIMENTS

Advantages of the present invention will become better understood with regard to the following description, appended claims, and accompanying drawings wherein:

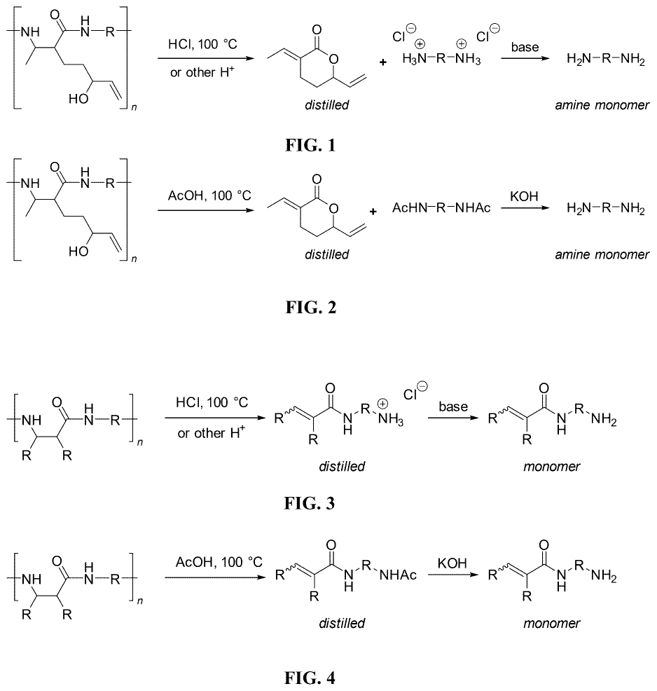

FIG. 1 is a schematic of a chemical pathway for recycling a butadiene-based polyamide via hydrochloric acid;

FIG. 2 is a schematic of a chemical pathway for recycling a butadiene-based polyamide via acetic acid;

FIG. 3 is a schematic of a chemical pathway for recycling a generic polyamide via hydrochloric acid;

FIG. 4 is a schematic of a chemical pathway for recycling a generic polyamide via acetic acid;

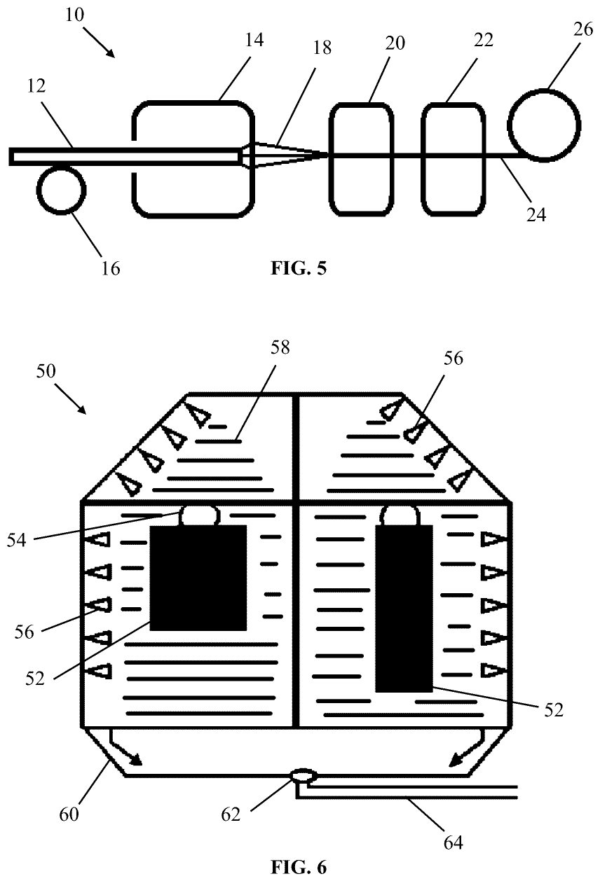

FIG. 5 is a schematic of a reverse pultrusion recycling system;

FIG. 6 is a schematic of a vapor phase recycling system;

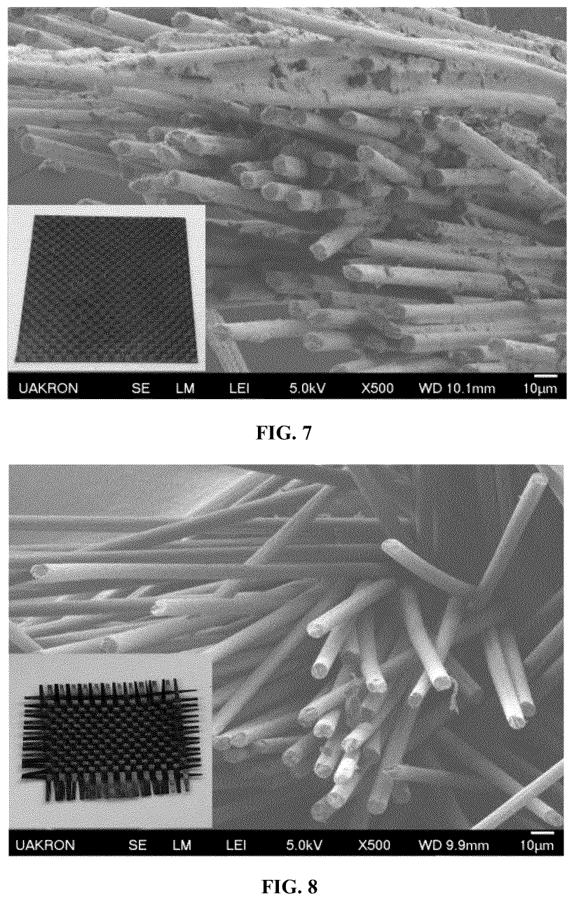

FIG. 7 is a scanning electron microscopy (SEM) image of a carbon fiber reinforced polymer composite with an inlayed optical image of the composite; and

FIG. 8 is a scanning electron microscopy (SEM) image of recycled and recovered carbon fibers from the composite of FIG. 7 with an inlayed optical image of the recovered fibers.

### DETAILED DESCRIPTION OF ILLUSTRATIVE EMBODIMENTS

One or more embodiments of the present invention relate to a recycling method for polymers. The recycling method may be particularly useful for recycling polyamides and corresponding composites containing a reinforcing component, such as fibers. The recycling method generally includes combining, which may be referred to as contacting, a polyamide thermoset with an acid. The acid generally serves to break polymeric carbon-nitrogen bonds. The combination of the polymer with the acid can be at an elevated temperature. Advantageously, the recycling method is able to recover the various monomeric components of the polymer. That is, for a polymer which is a polyamide made from an amine and a monomer formed from an olefin (e.g., butadiene) and carbon dioxide, the recycling method is able to recover both the monomer and the amine. The polymers made from carbon dioxide, an olefin, and an amine may also be referred to as co-polymers, polyamides, poly(aminoamides), or to-be-recycled polymers. Details of these materials are disclosed in International Publication No. WO 2023/164219, which is incorporated herein by reference.

As mentioned above, the method generally includes combining a polyamide thermoset with an acid. The method may be referred to as an acid-promoted depolymerization. Without being bound by theory, details as to the pathway from the polyamide species to the olefin/carbon dioxide monomer and amine are now provided, which details were in part spectroscopically analyzed with nuclear magnetic resonance (NMR).

When the amide species is exposed to acid at room temperature, the molecule forms a salt, shifting relevant ¹H NMR signals downfield. Once heated to elevated temperatures, the internal catalytic and stabilizing hydrogen bonding is affected, and subsequently the molecule undergoes retro-conjugate addition. The hydroxyl moiety, which has remained attached to the amide throughout the ring opening process, acts as a nucleophile in an intramolecular ring-closing mechanism, reforming the original monomer and releasing the amine species used in the reaction to form the polyamide. These amine species are sequestered by the acidic media to prevent reformation of the amide molecule. Once this chemical reaction has taken place, there are multiple methods by which the chemical species can be isolated and recovered.

Additionally, FIGS. 1-4 show certain chemical pathways. FIG. 1 shows the chemical pathway for recycling a butadiene-based polyamide via hydrochloric acid. FIG. 2 shows the chemical pathway for recycling a butadiene-based polyamide via acetic acid. FIG. 3 shows the chemical pathway for recycling a generic polyamide via hydrochloric acid. FIG. 4 shows the chemical pathway for recycling a generic polyamide via acetic acid.

The recycling method of combining a polyamide thermoset with an acid can take place in the presence of gaseous, solid, or liquid phase media. The acid can be any suitable acid that enables the recycling pathway. Exemplary acids include acetic acid, hydrochloric acid, sulfuric acid, nitric acid, phosphoric acid, boric acid, hydrofluoric acid, trifluoroacetic acid, hydrobromic acid, oxalic acid, and toluenesulfonic acid. The particular acid utilized can be based on a variety of factors, including environmental factors and manufacturing desired. This can include considering the strength of the acid or corresponding solution, which will be readily understood by the skilled person. In one or more embodiments, the strength of an acid or corresponding solution can correspond to about 1 M acetic acid or stronger.

The recycling method of combining a polyamide thermoset with an acid can take place in the presence of an added catalyst, which would be included in a catalytic amount. The catalyst can be any suitable Lewis acid catalyst. Exemplary Lewis acid catalysts include zeolite catalysts and metal halides, such as aluminum chloride, titanium chloride, and zinc chloride.

In one or more embodiments, the combination of the polyamide thermoset with an acid may be at room temperature (e.g., about 20° C. to 22° C.). In one or more embodiments, the combination of the polyamide thermoset with an acid may be at a temperature of greater than 50° C., or greater than 75° C., or greater than 90° C., or greater than 100° C., or greater than 150° C. In these or other embodiments, the combination of the polyamide thermoset with an acid may be at a temperature of less than 200° C., or less than 150° C., or less than 125° C., or less than 100° C. In one or more embodiments, the combination of the polyamide thermoset with an acid may be at a temperature of from about 50° C. to about 200° C., or from about 75° C. to about 175° C., or from about 75° C. to about 125° C., or from about 100° C. to about 150° C., or from about 100° C. to about 125° C., or from about 100° C. to about 200° C.

In one or more embodiments, the combination of the polyamide thermoset with an acid may be at a time of from about 10 minutes to about 3 hours, or from about 10 minutes to about 30 minutes, or from about 20 minutes to about 40 minutes, or from about 1 hour to about 6 hours, or from about 1 hour to about 2 hours, or from about 30 minutes to about 1 hour. In these or other embodiments, the combination of the polyamide thermoset with an acid may be a time of at least 30 minutes, at least 1 hour, or at least 2 hours, or at least 4 hours, or at least 12 hours, or at least 24 hours. Other suitable times will be generally understood by the skilled person.

In one or more embodiments, the combination of the polyamide thermoset with an acid may be at ambient pressure (e.g., about 14.7 psi). In one or more embodiments, the combination of the polyamide thermoset with an acid may be at a pressure of up to 20 psi, or up to 30 psi, or up to 50 psi, or up to 70 psi.

The various conditions for the combination of the polyamide thermoset with an acid can be based on the mass transfer limitation for any given materials.

As mentioned above, a variety of methods can be utilized for isolating and recovering the chemical species from a polyamide thermoset. Exemplary techniques include solvent extraction, distillation, and precipitation. These techniques can take place at suitable depressed or elevated pressures and temperatures, including the pressures and temperatures specifically disclosed herein.

The two compounds (i.e., olefin/carbon dioxide monomer and amine species) can be isolated via solvent extraction. This can be done via multiple methods, such as aqueous-organic phase extractions and polar-nonpolar extractions, in a manner where the monomer and amine species are separated and can be retrieved via concentration of a suitable solvent. The thermoset could be placed into digestion media, such as heated acetic acid, to conduct the reversion of the reaction. Depending on the extraction procedure, the digestion media can be used as one phase of the extraction, or the digestion media can be concentrated and the digested thermoset components can be dissolved in a desired solvent for the extraction procedure.

The two compounds (i.e., olefin/carbon dioxide monomer and amine species) can be isolated via distillation. The thermoset can be placed in the digestion media for the digestion process. Once the monomer and ammonium salts have been generated, the digestion media can be arranged in a distillation apparatus. The distillation apparatus can include an adapter to pull vacuum on the system. The distillation apparatus can also include a heating source at the pitch and cooling source at the receiving ends of the setup. The digestion media can also be concentrated before setting up the distillation apparatus. Once assembled, the monomer can be distilled and collected. The ammonium salts would remain in the pitch, which can be recovered via methods such as neutralization and extraction to recover the amine species.

The two compounds can also be isolated via precipitation. This would include the thermoset being digested in media to generate the monomer and ammonium salt species. Following digestion, the media can be added to a secondary solvent or media to precipitate salts formed during digestion. This process can include first concentrating the digestion media prior to precipitation. Precipitation can also be conducted in the case where the amine species can be precipitated or recrystallized based on the manipulation of pressure, temperature, solvents, or acidity.

Where the polyamide in is the form of a composite containing a reinforcing component, such as fibers, the reinforcing component can also be recovered. The reinforcing component can be a variety of materials, including low carbon footprint reinforcement such as natural fibers, and high performance synthetic fibers such as carbon fiber. The reinforcing component can include particles or crystals of ranging size (including micro and nano particles) and fibers of various lengths. The reinforcing component can include carbon black, graphite, silica, nanotubes, clay, and graphene. The reinforcing component can be arranged in a variety of orientations and patterns to yield desired properties of the composite. Application of the resin with the reinforcing component to form a composite can occur through a variety of methods, such as pultrusion, compression molding, vacuum infusion, and hand-layup. Recyclability of the composites make these fibers recoverable, and the mild to moderate conditions used to recycle the thermoset described herein do not destroy the integrity of the fibers, including no or minimal modification of the surface, such as sizing agent functional groups. This facilitates recovery and reuse of the fibers used in composites made using the polyamide thermoset. The recovery of the reinforcing component (e.g., fibers) can be up to 100 wt. %, or at least 99.8 wt. %, or at least 99.5 wt. %, or at least 99 wt. % of the original fibers. The recovered material including the recovered reinforcing component (e.g., fibers) can be less than 1 wt. %, or less than 0.8 wt. %, or less than 0.5 wt. % of the polymer. Visualization as to the amount of polymer remaining with the recovered reinforcing component can be done via scanning electron microscopy (SEM) imaging and quantification can be done via thermogravimetric analysis (TGA).

The composites can be recycled through various procedures. Exemplary techniques include use of a reservoir, retro-pultrusion, infusion, and a gas/vapor phase technique. These techniques can take place at suitable depressed or elevated pressures and temperatures, including the pressures and temperatures specifically disclosed herein.

Composites can be recycled by submerging the composite into media held in a reservoir or vat. The reservoir may include one or more of sections, a rack system, and arrangement of hangars and/or clamps to suspend or hold composite products being recycled. The reservoir can be arranged to facilitate the recycling methods for the thermoset, including temperature, pressure, and media type. The media can be stagnant, to help with preservation of fiber alignment and orientation, or can be flowing and/or stirred, which can serve to increase recycling rates. The reservoir can be arranged such that the media can be collected and diverted for monomer and amine recovery, followed by rinsing and drying of the fibers. The reservoir can also be arranged such that concentration and recovery takes place from this reservoir in a ‘one-pot’ type reactor. The reservoir can also be in line with a spool to retrieve the collected fiber after the process.

Composites can be recycled in a ‘retro-pultrusion’ method, where the composite can be pulled along a path through which the composite undergoes the entire process of digestion of the matrix, rinsing and drying of the fibers, and winding the recycled fibers into a spool. This method provides modularity at multiple stages. A composite can be fed into a digestion chamber or reservoir by a roller, puller, or pusher. In the reservoir, the composite can be exposed to the digestion media. This can be by spray or mist, a continuous flow, submergence, or other type of application of the media. The digested matrix can be captured in this stage, and the free fibers can be pulled through a rinsing basin to remove residual media, then suitably dried in a dryer, and then stored on a spool. This method can provide improved control over fiber orientation and alignment through a continuous process which offers high throughput and reverse mimics the method of pultrusion utilized in composite manufacturing.

Composite recycling can be performed through an infusion with digestion media. The part can be secured within a mold that follows the profile of the composite part to be recycled. The mold can then be infused with digestion media. This mold can be arranged to include heating and cooling elements for temperature control. Once the thermoset is digested and the generated species are homogenous, the media can be removed by a method such as draining and collected to isolate the monomer and the ammonium species for recycling of the polyamide starting materials. The fibers would remain held within the mold, preserving fiber alignment, orientation, and shape relative to the profile of the original composite placed in the mold. The fibers can be removed from the mold, or the mold can be arranged such that the fibers are rinsed, dried, and then infused with resin and cured in a one-pot type recycling and curing process. The mold may also be arranged such that isolation methods can be performed directly, such as distillation of the olefin/carbon dioxide monomer.

Composite recycling can be performed in a gas or vapor phase method. This method may include a basin in which the composite is laid on a rack or held up by hangers or clamps. To the sealed basin, the digestion media can be introduced either as a heated vapor or a gas phase media. Exposure to the media in the gaseous state allows for uniform application and can be modulated via pressure or temperature. Fans can be used to increase gas flow and circulators can be used to maintain the environment of the basin during and after recycling. The digested material can be collected in a catch reservoir, typically at the bottom of the chamber, and diverted for isolation of the monomer and ammonium species. The basin can also be arranged for direct isolation by methods such as distillation. In a similar fashion that the digestion media can be introduced to the basin, gas phase or a liquid spray or mist can be applied to rinse the fibers of residues. The basin can also be arranged to dry the fibers as well, resulting in the fibers being ready for reuse once removed from the basin. Use of a rack or hanger system will allow retention of the fiber orientation and alignment.

In or more embodiments, techniques disclosed herein can be a continuous or semi-continuous method. For example, a method can take place in a continuous or semi-continuous manner in which new material can be fed into the system to improve throughput of the recycling process. This includes the continuous or semi-continuous isolation and recovery of the generated monomer and ammonium salt, neutralization of the salt to regenerate amine species, and regeneration of the digestion media to increase throughput of the components of the recycling procedure and the recycled products yielded from the various procedures.

Schematics for certain exemplary recycling systems, according to one or more embodiments of the present invention, are shown in FIG. 5 and FIG. 6. FIG. 5 shows a reverse pultrusion recycling 10 where a composite product 12 could be recycled. Composite product 12, which could be a long tubular construction used for telecommunication poles, can be fed into a recycling bath 14 by a roller 16. Inside the bath 16, the acid can be provided, such as via a heated mist. The acid (e.g., heated mist) can be applied to the composite material 12 to recycle the thermoset polymer thereof. Released fibers 18 can be pulled along a path into a rinsing basin 20. In the rinsing basin 20, aqueous neutralizing media can be applied, such as by spraying, onto the released fibers 18 to remove residues and to neutralize any residual acid. The fibers 18 continue along the path to a dryer 22 for suitable drying of the released fibers 18. Dried and collected fibers 24 can then be spooled on a spool 26 to effectively store the dried and collected fibers 24, which may also be referred to as recycled fibers 24. These spools 26 can be transferred to or placed in-line with a pultrusion machine to manufacture new composites with the recycled fibers 24.

FIG. 6 shows a vapor phase recycling basin 50. Within vapor phase recycling basin 50, one or more composite products 52 can be recycled. Composites 52 can be held by respective hangers 54 inside of the basin 50. The composites 52 can be surrounded by vapor inlets 56. Vapor inlets 56 can inject vaporized digestion media 58 (i.e., acid) into the basin 50 from a variety of directions. Vaporized digestion media 58 can convert the solid thermoset polymer of the composites 52 into a homogenous liquid that can drain to a bottom 60 of the basin. The collected liquid can exit via a drain 62 and corresponding plumbing 64 for reuse of the monomers. The plumbing 64 can be coupled with a reactor, or other suitable collection location, where the monomers can be isolated for reuse. The hangers 54 should be designed in order to accommodate the lost volume of the thermoset being removed from the fibers of the composites 52. If the hangers 54 include clamps, the clamps should apply increased pressure as the thermoset digests. After the thermoset of the composites 52 would be removed as the liquid, the inlets 56 can inject a rinsing solution to remove residue and neutralize any digestion media from the remaining fibers. Once dry, the remaining fibers, which may be referred to as recycled fibers, can be removed from basin 50 and used to manufacture a new composite.

As mentioned above, details of the polyamide materials, which may be referred to as the to-be-recycled polymer, are disclosed in International Publication No. WO 2023/164219, which is incorporated herein by reference. Certain details are also specifically included here. The polymers made from carbon dioxide, an olefin, and an amine may also be referred to as co-polymers, polyamides, or poly(aminoamides). Formation of the polymer generally includes conversion of carbon dioxide (CO₂) with an olefin. Any suitable olefin may be utilized for reaction with the CO₂. The olefin may be acyclic or cyclic. Exemplary acyclic olefins, which may also be referred to as linear olefins, include 1,3-butadiene, ethylene, and isoprene. Exemplary cyclic olefins include cyclohexadiene, norbornadiene, and α-phellandrene. The olefin may be obtained from a renewable source or a petroleum source.

The carbon dioxide is chemically bonded, which may also be referred to as chemically incorporated, with the olefin. Relative to combination of the carbon dioxide and olefin with an amine, the term amine can refer to an overall compound containing one or more amine groups, or can refer to the one or more amine groups, which groups may also be referred to as amino groups. The amine, which may also be referred to as an amine-containing compound, an amine compound, can be a monoamine or a polyfunctional amine. Exemplary polyfunctional amines include a difunctional amine, a trifunctional amine, and a tetrafunctional amine. Polyfunctional amines may be desirable relative to producing polymeric end products, though the products made from monoamines may have other desirable applications. An exemplary amine-containing compound is a polymer functionalized with amino groups.

Exemplary monofunctional amines include methylamine, butylamine, hexylamine, octylamine, amine, benzyl glycosamines, 1-(2-Aminocthyl) pyrrolidine, N-Boc-N-methylethylenediamine, 4-(2-Aminoethyl) morpholine, or amino acids. Polymeryl amines such as polyethylene amine, polypropylene amine, polybutadiene amine, polyisoprene amine may be utilized. Functionalized amines such as furfuryl amine, acylated amines such as 2-aminoethyl acrylate, and maleimides such as 1-(2-aminoethyl)-1H-pyrrole-2,5-dione may be utilized. Other monofunctional amines include dopamine, aminosiloxanes such as (3-aminopropyl) trimethoxysilane, and perfluorinated alkyl amines such as 1H,1H-perfluorooctylamine.

Exemplary difunctional amines include 1,2-ethylenediamine, 1,4-butanciamine, 1,6-hexanediamine, 1,8-octanediamine, isophorone diamine, diethylenetriamine, furfuryl diamine, N′-bis(3-aminopropyl)-1,3-propanediamine, 3,3′-diamino-N-methyldipropylamine, 1,2-bis(3-aminopropylamino) cthane, 1,4-bis(3-aminopropyl) piperazine, and di-end functionalized polymeryl amines (also known as telechelic polymers) such as telechelic polyethylene diamine, nylons, polydimethylsiloxane diamine, polypropylene diamine, polybutadiene diamine, and polyisoprene diamine. Disulfide containing diamines such as (disulfanediylbis(4,1-phenylene))dimethanamine may be utilized.

Exemplary trifunctional amines include tris(2-aminoethyl)amine. Additional examples include tris(3-aminopropyl)amine, 1-(2-aminoethyl) piperazine, 4-(aminomethyl) piperidine, and 2-(aminomethyl)-2-methyl-1,3-propanediamine. Exemplary tetrafunctional amines include polypropylenimine tetramine dendrimer, and 2,4,6-triethyl-1,3,5-benzenetrimethanamine.

The combination of the carbon dioxide and olefin can be a lactone. Lactones can be generally described as cyclic carboxylic esters, containing a 1-oxacycloalkan-2-one structure (—C(═O)—O—). Lactones may also include analogues having unsaturation or heteroatoms replacing one or more carbon atoms of the ring. Lactones include disubstituted lactones, unsaturated lactones, or disubstituted unsaturated lactones.

An exemplary range of repeat units for the to-be-recycled polymer is from about 50 to about 500 repeat units. In other embodiments, molecular weights ranging from 500 to 10,000 repeat units may be utilized. When trifunctional, tetrafunctional, or multifunctional amines are used, crosslinked thermosets can be formed with an incalculably large number of repeat units.

In one or more embodiments, the number average molar mass (Mn) for the to-be-recycled polymer may be about 2,000 g/mol, or about 60,000 g/mol, or an incalculably high molecular weight for any crosslinked polymer products. In one or more embodiments, the to-be-recycled polymer may have a number average molar mass (Mn) of from about 500 g/mol to about 2,000 g/mol, or from about 2,000 g/mol to about 10,000 g/mol, or from about 10,000 g/mol to about 100,000 g/mol, or from about 100,000 g/mol to about 5,000,000 g/mol.

### EXAMPLES

### Example 1/Comparative

A poly(amidoamine) polymer was made from tris(2-aminoethyl)amine (TREN) and a carbon dioxide/butadiene lactone. The mechanical test specimens were prepared in a two-stage process of first heating at 80° C. for 30 minutes, followed by heating at 150° C. for 1 hour. To understand the stability of the network of this material, a chemical-resistance study was conducted. As shown in Table 1, for this material, in the presence of solvents (acetone, DMF, MeCN, MeOH, H₂O) and basic conditions (1M NaOH) the gel fractions remained above 90% after 24 hours of submersing the specimens, indicating the network of this material had not lost percolation connectivity. However, when this material was heated to 100° C. in acidic environments (e.g., AcOH), the gel fraction decreased, relative to the same 24 hour time period.

As additional detail, all samples were dried in vacuum oven at 60° C. for 24 hours, values above 100% are expected to be a result of the formation of ammonium salts with the poly(amidoamine) networks, and the experiments were performed in triplicate.

TABLE 1
Sol-gel study gel fraction results.

| Solvent | Mean (%) | St. Dev. |
|---|---|---|
| HCl conc. | 128.2 | 4.2 |
| 1M HCl | 114.5 | 0.8 |
| CH₂Cl₂ | 109.1 | 2.5 |
| 1M NaOH | 102.0 | 1.4 |
| Acetone | 101.7 | 3.4 |
| DMF | 99.7 | 2.2 |
| MeCN | 98.8 | 1.6 |
| H₂O | 95.7 | 1.4 |
| n-Butylamine | 95.0 | 1.1 |
| MeOH | 90.6 | 1.5 |
| AcOH | 90.5 | 5.4 |
| 1M HCl 100° C. | 5.5 | 0.4 |
| AcOH 100° C. | 0.0 | — |

After exposure to acid, it was anticipated that the amide moiety would be stable and that the retro-aza-Michael elimination would occur to produce a mixture of mono-, di-, and tri-tiglamide products. However, these species were not observed spectroscopically. Instead, the major product observed by 1H NMR was the carbon dioxide/butadiene lactone. Although reversible lactonization of the amide moiety by the intramolecular cyclization of the alcohol is considered thermodynamically unfavored in the reaction equilibrium, when this material was heated to 100° C., the equilibrium process was shifted thereby funneling the reaction products to the starting lactone. Unlike a condensation polymerization, the departing alkoxy remains covalently attached in the products from the lactone, which imparts atom economy and mild chemical recyclability in these thermosets. Analysis by 1H-NMR showed reversion to the lactone in an observed yield of 72%, which could be experimentally recovered by simple organic extraction with a 20:80 ethyl acetate:hexanes organic phase (45% isolated yield), yielding the lactone in a 25:1 ratio of E/Z isomers, consistent with a retro-thia-Michael sequence.

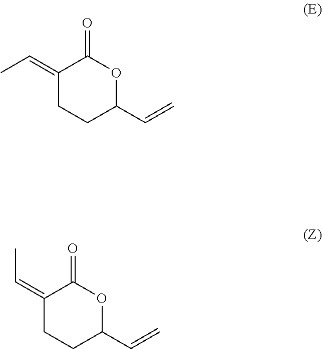

Alternatively, direct distillation was also suitable for chemical recycling of the monomer (41% isolated yield), and the unsaturated lactone was isolated in a 10:1 ratio of E/Z isomers with this procedure, with the amine recovered from the pitching flask as TREN-trisacetate. The TREN-trisacetate was hydrolyzed with KOH at 150° C. to afford TREN in a 22% overall yield. Notably, the crude solution NMR analysis indicated good yields and purity, such that material losses were attributed to intractable crosslinking side reactions that result from the divergent reactivity of the lactone and its derivatives.

### Example 2

Poly(amidoamine) carbon fiber reinforced polymers (CFRPs) with recoverable fibers were prepared by a hand-layup procedure of resin, made from tris(2-aminoethyl)amine (TREN) and a carbon dioxide/butadiene lactone, with four plies of 3K continuous plain weave carbon fiber. This prepreg was cured using a low-temperature pre-cure at 80° C. for 30 minutes followed by a high-temperature curing period at 150° C. for 1 hour. The poly(amidoamine) CFRP was analyzed for tensile strength, Young's modulus, flexural strength, and flexural modulus properties.

A scanning electron microscopy (SEM) image (FIG. 7) of the cross section of a fractured poly(amidoamine) CFRP specimen revealed that the polymer penetrates between fibers, which is facilitated by low initial viscosity of the resin made from the tris(2-aminoethyl)amine and the carbon dioxide/butadiene lactone. The cleavable network enabled both the monomer and the carbon fiber fabrics to be recovered via degradation of the rigid composite in acetic acid at 100° C. for 1 hour. The flexible fiber weave was removed from the acid, rinsed with water, dried in a vacuum oven at 60° C., and analyzed by SEM (FIG. 8). The SEM image showed no evidence of residual resin on the fibers, which was corroborated by thermogravimetric analysis (TGA) that demonstrated a <1.0 wt. % difference between the virgin and recovered fibers at 500° C. The acetic acid solution containing the carbon dioxide/butadiene lactone could then be recycled through a diethyl ether (Et20) precipitation or distillation procedure. With the recovered carbon fibers, performance was tested of a recycled CFRP by re-fabricating a panel made from the resin (i.e., made from the tris(2-aminoethyl)amine and the carbon dioxide/butadiene lactone) along with the visually pristine recovered fibers. This recycled CFRP, which included 56 wt. % carbon fibers, exhibited no loss in mechanical properties, suggesting that the mild digestion conditions caused negligible damage to the fiber surface when used with the poly(amidoamine) resin.

### Example 3

To a 50 mL round bottom flask with a stir bar, an orange color polymer matrix made from tris(2-aminoethyl)amine (TREN) and a carbon dioxide/butadiene lactone (3.2 mmol, 2.4 g) was added followed by the addition of AcOH (470 mmol, 28.2 g). The flask was sealed with a rubber septa and a ballon was added to equalize pressure. The mixture was placed in an oil bath and heated to 100° C. for 24 hours. The orange polymer matrix immediately began swelling and the mixture became homogenous around the 1-hour mark, forming a dark brown solution. After 24 hours, the mixture was removed from heat and a crude aliquot was collected for 1H NMR analysis (0.254 g). NMR solvent was prepared by dissolving an internal standard of 1,4-bis(trimethylsilyl)benzene (0.01 mmol, 2.2 mg) in 0.7 mL of CDCl3. The crude aliquot was then dissolved in the NMR solution and transferred to an NMR tube for analysis, where the carbon dioxide/butadiene lactone was observed in both E and Z isomers (1.06 g, 72% yield).

### Example 4

Following the digestion procedure of Example 3, the flask of crude digestion mixture was then added to a vacuum distillation apparatus. Vacuum was gently introduced while stirring the digestion mixture and increasing heat at a rate of 10° C. every 10 minutes in order to avoid bumping the AcOH. Once at 80° C. and when nearly all AcOH was collected in the first fraction, a second fraction was started, and heating was increased to 100° C. Vacuum distillation proceeded at 100° C. for approximately 4 hours at a vacuum of <300 mtorr and the carbon dioxide/butadiene lactone was visually seen distilling. Temperature of the glass between the pitching flask and condenser portion of the distillation apparatus was monitored using an infrared thermometer and occasionally heated no higher than 100° C. and wrapped with foil to promote efficient distillation. After approximately 4 hours, a final fraction began, and temperature was increased to 120° C. in an attempt to drive off the carbon dioxide/butadiene lactone from the pitching flask. The carbon dioxide/butadiene lactone was collected as a beige to colorless liquid (yield 0.571 g, 39% yield).

### Example 5

Polymer matrix made from tris(2-aminoethyl)amine (TREN) and a carbon dioxide/butadiene lactone (1.9 mmol, 1.4 g) was digested following the same digestion procedure in Example 3. The digestion solution was concentrated via rotary evaporation to remove free AcOH. To the remaining material was added DI H₂O (80 mL). The aqueous solution was then transferred to a separatory funnel, and the carbon dioxide/butadiene lactone was extracted with 20:80 EtOAc:Hexanes (3×50 mL). The organic layer was collected, dried with Na₂SO₄, and concentrated, affording the carbon dioxide/butadiene lactone as a beige liquid residue (0.434 g, 51% yield).

### Example 6

Polymer matrix made from tris(2-aminoethyl)amine (TREN) and a carbon dioxide/butadiene lactone (1.9 mmol, 1.4 g) was digested following the same digestion procedure in Example 3. The digestion solution was concentrated via rotary evaporation to remove free AcOH. The same organic extraction procedure from Example 5 was used. The aqueous layer was collected, concentrated, and this remaining matrix material post digestion was massed (1.570 g). This residue included the remaining carbon dioxide/butadiene lactone and TREN, including acetylated TREN species. An aliquot (0.194 g) of this 48 wt. % TREN residue was added to excess KOH and heated for 18 hours at 150° C. The brown residue was rinsed with CHCI3, and the solution dried to recover TREN as a yellow residue (20.8 mg, 22% yield).

### Prophetic Example 1

A thermoset composite product, which could be a bicycle frame, could be placed on a rack and submerged into a reservoir full of heated acetic acid. The composite would then be digested into a homogenous solution of monomer (e.g., made from butadiene/carbon dioxide) and ammonium salts. After being fully digested, the rack could be lifted from the reservoir and moved to a rinsing basin where basic aqueous media would rinse any of the residual digestion solution and neutralize remaining acid. The rack could then be transferred to a dryer. After being dried, the fibers could be moved to machinery for realignment or to be immediately reused in a new composite product. The digestion media in the basin could be reused through multiple iterations of recycling. Once expired, in this example the media could be drained from the reservoir, concentrated to remove bulk solvents, and transferred to a vacuum distillation apparatus to recover the monomer. The remaining pitch would contain ammonium salts, which could then be neutralized and separated to recover the amine species.

### Prophetic Example 2

A thermoset composite product, which could be a long tubular construction used for telecommunication poles, could be recycled. The pole could be fed into a recycling bath by a roller. Inside the bath, a mist of heated 1M HCl could be applied to the material to recycle the thermoset. The released fibers could be pulled along a path into a rinsing basin, where aqueous neutralizing media could be sprayed onto the fibers to remove residues and neutralize any residual 1M HCl. The fibers would continue along the path to a dryer and would be spooled to effectively store the recycled fibers. These spools could be transferred to or placed in-line with a pultrusion machine to manufacture new composites with recycled fibers.

### Prophetic Example 3

A composite panel from an automobile body, such as a front quarter panel, might have a scratched surface that cannot be repaired. The panel might be made using vacuum-assisted infusion in a mold. The same profile mold that might be used to manufacture the panel could be used for recycling by placing the expired panel into the mold and filling the mold with heated acetic acid. Once homogenous, the digestion media could be drained from the mold and the mold could then be filled with a rinsing agent and drained again. The mold could then be dried by applying heat and gently passing air through the mold. Once fully dry, the mold could be treated as a vacuum-assisted infusion mold to manufacture a new panel with the recycled fibers. Resin could be infused and cured, yielding the new quarter panel.

### Prophetic Example 4

A composite product to be recycled could be placed in a gaseous or vapor phase basin. The one or more composites could be held by hangers inside of the basin, and could be surrounded by vapor inlets. Vaporized digestion media could then be injected into the basin from all directions to convert the solid thermoset polymer into a homogenous liquid that would drain to the bottom of the basin. The solution could be plumbed to a reactor where the monomers would be isolated for reuse. The hangers would be designed in order to accommodate the lost volume of the thermoset being removed from the fibers. The hangers could be clamps that would apply increased pressure as the thermoset digests. After the thermoset were removed, the inlets could inject a rinsing solution to remove residue and neutralize any digestion media. Once dry, the fibers could be removed and used to manufacture a new composite.

In light of the foregoing, it should be appreciated that the present invention significantly advances the art by providing an improved recycling method. While particular embodiments of the invention have been disclosed in detail herein, it should be appreciated that the invention is not limited thereto or thereby inasmuch as variations on the invention herein will be readily appreciated by those of ordinary skill in the art. The scope of the invention shall be appreciated from the claims that follow.

What is claimed is:

1. A method of recycling a polymer, the method comprising steps of
contacting a polyamide polymer with an acid;
allowing the polyamide polymer to depolymerize in presence of the acid into an amine species and a monomer based on an olefin and carbon dioxide; and
collecting the amine species and the monomer.

2. The method of claim 1, wherein the amine species is a polyfunctional amine compound.

3. The method of claim 2, wherein the polyfunctional amine compound is selected from a diamine compound, a triamine compound, and a tetraamine compound.

4. The method of claim 1, where the polyamide polymer is part of a composite further including a reinforcing component, such that the step of collecting further includes collecting the reinforcing component.

5. The method of claim 4, where the reinforcing component includes fibers.

6. The method of claim 5, wherein the fibers include carbon fibers.

7. The method of claim 4, where the reinforcing component is selected from graphite, nanotubes, and graphene.

8. The method of claim 1, where the step of allowing the polyamide polymer to depolymerize in presence of the acid occurs at a temperature of greater than 75° C.

9. The method of claim 1, where the step of allowing the polyamide polymer to depolymerize in presence of the acid occurs at a temperature of from about 75° C. to about 125° C.

10. The method of claim 1, where the step of allowing the polyamide polymer to depolymerize in presence of the acid occurs for at least 1 hour.

11. The method of claim 5, where the step of collecting includes collecting at least 99.8 wt. % of the fibers within the composite.

12. The method of claim 1, where the olefin is an acyclic olefin selected from 1,3-butadiene, ethylene, and isoprene.

13. The method of claim 1, where the olefin is a cyclic olefin selected from cyclohexadiene, norbornadiene, and α-phellandrene.

14. The method of claim 1, where the step of contacting the polyamide polymer with the acid includes spraying the acid on the polyamide polymer in vapor phase.

15. The method of claim 1, where the polyamide polymer is part of a composite further including fibers as a reinforcing component, such that the step of collecting further includes collecting the fibers, where the step of contacting the polyamide polymer with the acid includes feeding the composite into a bath where the acid is applied to the composite via a mist.

16. The method of claim 15, where the step of collecting the fibers includes spooling the fibers onto a spool.

17. The method of claim 1, where the acid is selected from acetic acid, hydrochloric acid, sulfuric acid, nitric acid, phosphoric acid, boric acid, hydrofluoric acid, trifluoroacetic acid, hydrobromic acid, oxalic acid, and toluenesulfonic acid.

18. The method of claim 1, further comprising a step of utilizing, after the step of collecting, the amine species and the monomer to form a new polymer.

19. The method of claim 4, further comprising a step of utilizing, after the step of collecting, the amine species, the monomer, and the reinforcing component to form a new composite.
